(19) United States
(12) Patent Application Publication
(10) Pub. No.: US 2025/0201215 A1
(43) Pub. Date: Jun. 19, 2025

(54) SYSTEM FOR HOLDING WOODWIND INSTRUMENTS

(71) Applicant: Nathan Owen Brown, Seattle, WA (US)

(72) Inventor: Nathan Owen Brown, Seattle, WA (US)

(21) Appl. No.: 18/542,578

(22) Filed: Dec. 15, 2023

(51) Int. Cl. G10D 9/00; G10D 7/08

(52) U.S. Cl. CPC G10D 9/00; G10D 7/08

(57) ABSTRACT

The present disclosure describes a support system for holding a woodwind musical instrument via varied hand grip sizes, shapes, and posture. In one aspect the system includes a rest piece having a curved hole slot through which mounting or fastening devices can travel along the curved hole slot to allow extreme adjustment of the rest piece for varied hand grip needs.

### TECHNICAL FIELD

The present disclosure generally relates to the field of musical instruments, and in particular, to the saxophone woodwind instrument.

### BACKGROUND

The weight of a woodwind musical instrument is often held by the musician in playing position via the use of thumb rest pieces such as flat rests or thumb hooks. Such rest piece devices force the musician's hand into awkward posture for extended periods of time under the weighted load of the instrument. Because of this, it is common for woodwind players to suffer hand fatigue, finger tension while playing, wrist and hand pain, or other damaging conditions such as tendonitis. These problems increase with age or the intensity of a musical career. To make matters worse, woodwind rest piece design focuses on average hand and finger sizes rather than allowing for different hand sizes, finger lengths, or medical conditions that may require a player to adjust their wrist, arm or hand placement when playing.

It is common for people with short arms or small hands who play tenor saxophone or baritone saxophone to experience wrist pain while playing because the saxophone's right thumb hook forces the hand into an unnatural grip, kinking wrist posture. It would be better to allow the player's right thumb to move and rest more freely to relieve stress and provide a more ergonomic playing experience.

It is common for music teachers to tell small children wanting to play the saxophone that they cannot because their hand is too small to reach around the saxophone body and key mechanism. While this may be true for very small children using common saxophone thumb hooks, a rest piece that could adjust to meet smaller hand grip sizes would allow children and people with short grips to enjoy playing saxophone.

It is common for saxophone players with very large hands to feel trapped under the right thumb rest hook of the saxophone because larger hands reach far beyond what traditional sax thumb hooks allow. This forces a player's hand into a cramped and uncomfortable posture.

Musicians can attempt to help relieve the discomfort and pain they feel from uncomfortable rest pieces by purchasing costly and complex ergonomic devices, or commissioning a modification to their musical instrument.

Woodwind musicians and especially saxophone players need a low cost device that can be added to the instrument easily and be mechanically adjusted by the player to accommodate all hand sizes, a variety of grip lengths, and variety of wrist positions. This would help decrease pain while playing and help introduce saxophone playing to more youth and women who generally have smaller hands.

### SUMMARY

The present disclosure describes a support system for holding a woodwind musical instrument via varied hand grip sizes, finger lengths, and hand posture.

### Terms

Various terms used in the present disclosure are described as follows, although such terms may have other descriptions included in the present disclosure.

“Musical Instrument,” “wind instrument,” or “instrument” refers to any portable woodwind instrument.

“Body,” or “body tube” refers to any part of a musical instrument used for the generation of sound, or the surface along which, or through which, the sound resonates and/or travels. The body includes the structure through which the forced air and/or sound vibrations flow.

“Rest Piece” refers to any portion of a woodwind instrument dedicated to a musician's thumb for helping grip or hold playing position. For example the left thumb flat rest of a saxophone or the right thumb hook of a saxophone. Another example is the right thumb rest of a clarinet. Such rest pieces may be permanently fixed to the instrument body tube, removable, or adjustable.

“Key Mechanism,” or “keys” refers to the body ribs, posts, rods, arms, key touches, key tabs, springs, key cups, pads, bumpers, guards, feet, levers, auxiliary levers, or a lyre holder of a musical instrument.

“Mechanically Adjustable” refers to the ability of mechanically changing the physical position of a rest piece in relation to the musical instrument or musician's hand. Recitation of “Mechanical Adjustability” or “Mechanically Adjusted” refers to “Mechanically Adjustable”.

### BRIEF DESCRIPTION OF THE ILLUSTRATIVE EMBODIMENTS

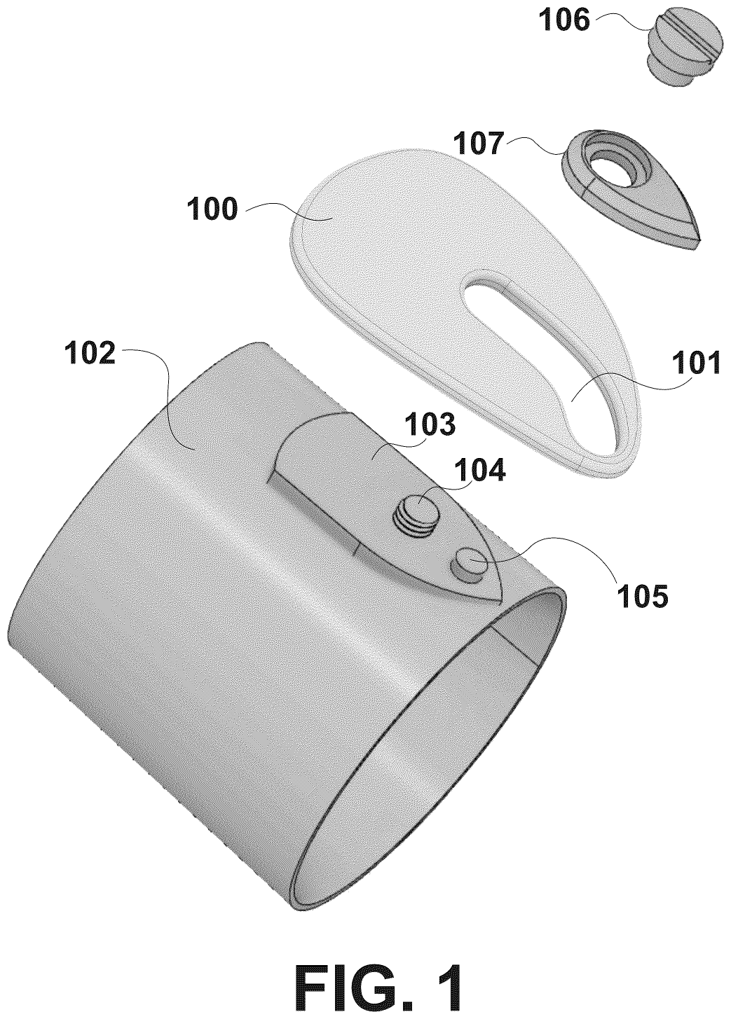

FIG. 1 shows an exploded view of an example thumb rest piece system for holding a saxophone via varied hand grip size, shape, and posture.

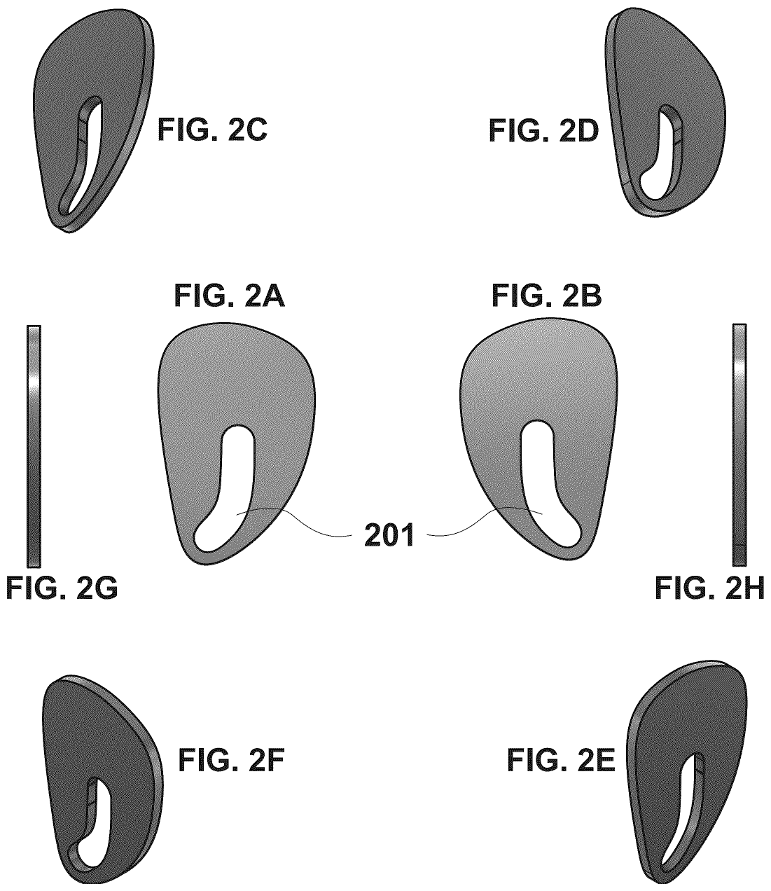

FIG. 2A through FIG. 2H show different view angles of an example thumb rest piece.

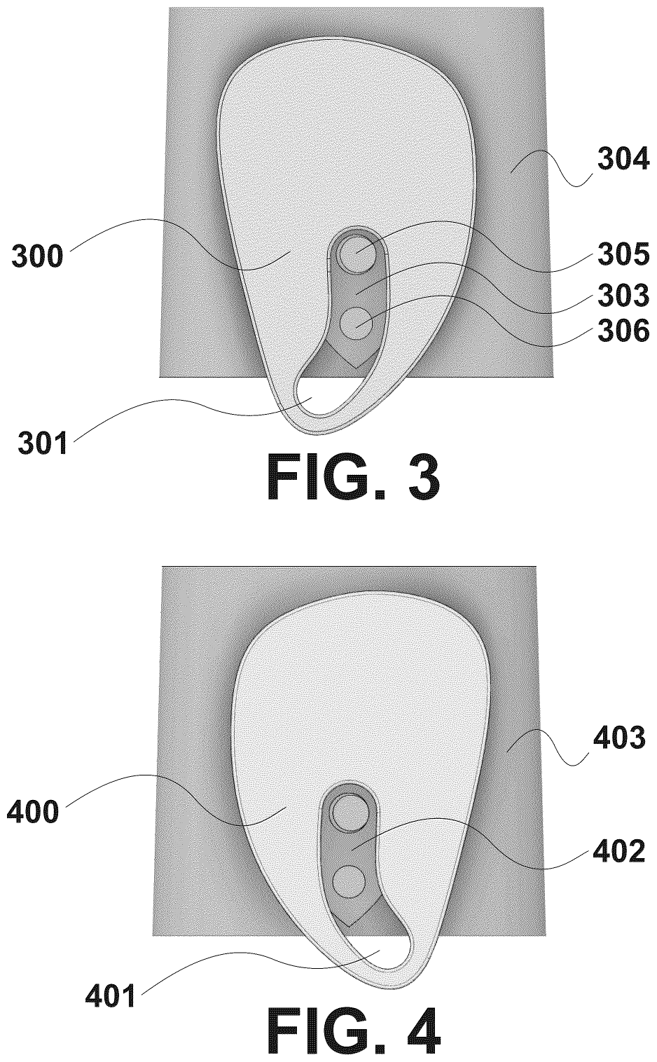

FIG. 3 shows a section of a saxophone body tube having an example thumb rest piece in the face up position laying against the saxophone thumb hook mounting plate.

FIG. 4 shows a section of a saxophone body tube having an example thumb rest piece in the face down position laying against the saxophone thumb hook mounting plate.

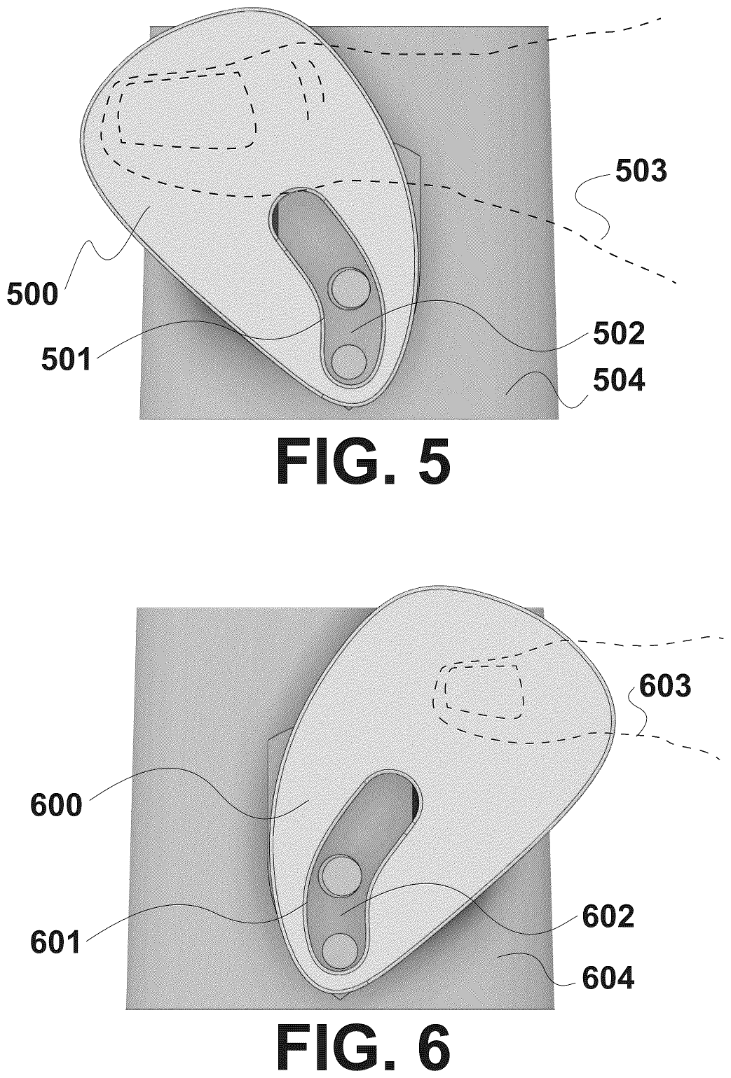

FIG. 5 shows a section of a saxophone body tube having an example thumb rest piece in the face up position lying against the saxophone thumb hook mounting plate. The curved slot in the rest piece allows the rest piece to be guided and positioned up and left along on the taper of the saxophone body tube. A large right thumb is also shown touching the example rest piece.

FIG. 6 shows a section of a saxophone body tube having an example thumb rest piece flipped to the face down position lying against the saxophone thumb hook mounting plate. The curved slot in the rest piece allows the rest piece to be guided and positioned up and right along on the taper of the saxophone body tube. A small right thumb is also shown touching the example rest piece.

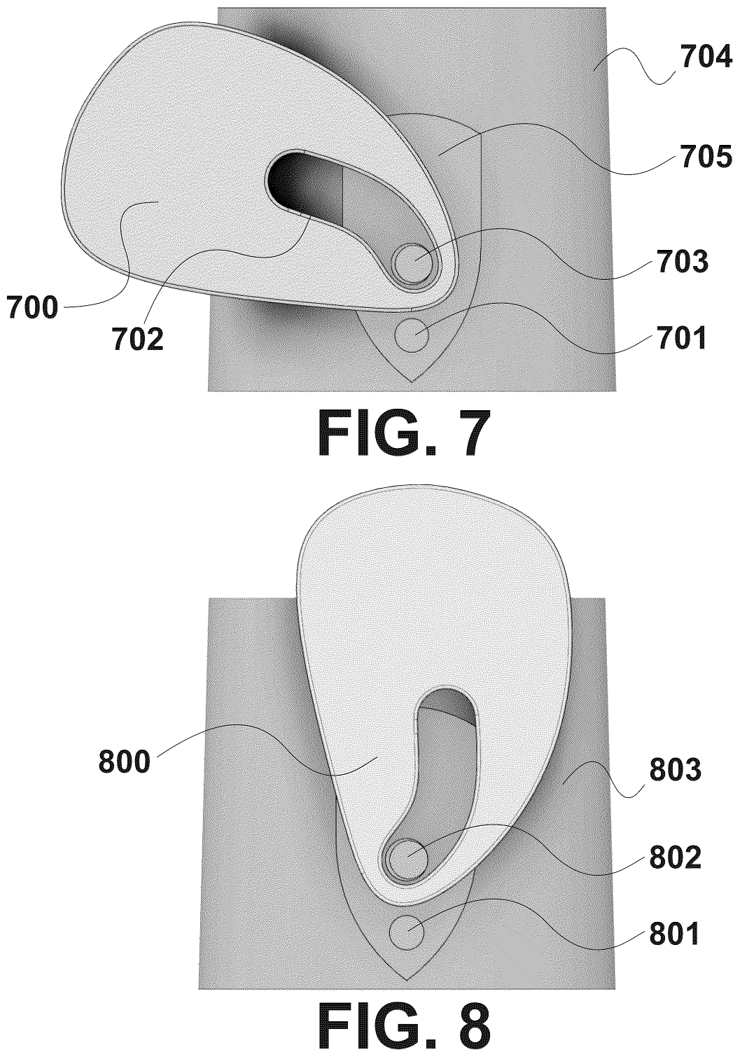

FIG. 7 shows a section of a saxophone body tube having an example thumb rest piece in the face up position rotated extremely far left and lying against the saxophone thumb hook mounting plate.

FIG. 8 shows a section of a saxophone body tube having an example thumb rest piece in the face up position placed extremely high along on the taper of the saxophone body tube and lying against the thumb hook mounting plate.

### DETAILED DESCRIPTION

It should be noted that although various systems are described below with reference to holding a saxophone, systems are not intended to be limited only to holding saxophones. The systems may be scaled and adjusted to work with any woodwind musical instrument.

FIG. 1 shows an exploded view of an example thumb rest piece system for holding a saxophone with varied hand grip size, hand shape, and hand posture. The system comprises a rest piece 100 that includes a curved hole slot 101. The rest piece 100 mounts to the saxophone body tube 102 (shown here as a body tube cross section as the player would view the sax with neck socket toward upper left) via the traditional saxophone thumb rest mounting plate 103 which is commonplace in the field and often includes some manner of screw mount 104 and positioning pin 105. The screw mount 104 and positioning pin 105 pass through the curved hole slot 101 of the rest piece 100 allowing the rest piece 100 to be fastened onto the mounting plate 103 via a locking nut 106 which often includes a washer shown here as a teardrop washer 107. The interaction between the curved hole slot 101 of rest piece 100 and the common saxophone mounting system including 103, 104, 105, 106, 107, allows for rotation and upward or downward mechanical adjustability to better accommodate different hand sizes, finger lengths, and hand postures.

FIG. 2A through FIG. 2H show different view angles of an example thumb rest piece. FIG. 2A shows a rest piece from a top view looking at the rest piece face up. FIG. 2B shows a rest piece from a bottom view with the rest piece face down. Notice that FIG. 2A and FIG. 2B show the curved hole slot 201 through which the commonly used rest piece mount system detailed in FIG. 1 can fasten the rest piece to a musical instrument body and allow a musician to mechanically adjust position of the rest piece left, right, up or down along the path of the curved hole slot 201.

FIGS. 2C, 2D, 2E, 2F show off axis orbital views of a rest piece.

FIGS. 2G and 2H show side views of a rest piece.

FIG. 3 shows rest piece 300 in the face up position having a curved hole slot 301 originating in the left lower quadrant and curving up. Rest piece 300 is placed against the saxophone mounting plate 303 of a saxophone body tube section 304. The curved hole slot 301 allows the saxophone screw mount 305 and positioning pin 306 to pass through rest piece 300 for guided position adjustment and screw locking onto the instrument body tube 304 (not shown in this angle view but illustrated in FIG. 1.)

FIG. 4 shows a rest piece 400 (flipped opposite the position shown in FIG. 3) in a face down position so the curved hold slot 401 originates in the right lower quadrant and is curving upward. The Rest piece 400 is shown placed against the mounting plate 402 of the saxophone body tube 403.

FIG. 5 Shows a rest piece 500 in the face up position against the mounting plate 502. The curved hole slot 501 is curving left and guiding position of the rest piece 500 up the sax body and left from the sax mounting plate 502 so a large right hand with longer thumb 503 can reach comfortably around the saxophone body tube 504 allowing for secure hand holding contact with the rest piece 500.

FIG. 6 shows a rest piece 600 flipped in the face down position against the mounting plate 602 so the curved hole slot 601 is curving right to guide rotation and extension for smaller hands with a shorter right thumb 603 to reach around the sax body tube 604 and make secure holding contact with the rest piece 600.

As shown in FIGS. 5 and 6, flipping the rest piece 500 and 600 allows the curved hole slot 501 and 601 to guide placement of the rest piece 500 and 600 towards up or down and right or left along the related radius of the curved hole slot so a musician can adjust position to serve a variety of grip lengths and rest positions including very small hands 603 or very large hands 503.

FIG. 7 shows an extreme rotation option of the rest piece 700 to serve very large hands. This is achieved by ignoring the use of positioning pin 701 and placing the curved hole slot 702 over the screw mount 703. By ignoring positioning pin 701 the rest piece 700 can rotate radically around screw mount 703 and provide even more extension away from the saxophone body tube 704 for large hands reaching around the body tube 704. Alternatively, if a musician flips the rest piece 700 face down against mounting plate 705, the curved hole slot 702 curves right and guides the rest piece 700 to extremely rotate up and right to accommodate very small hands similar to FIG. 6.

FIG. 8 shows another example of the rest piece 800 ignoring positioning pin 801 and achieving extension upward along the saxophone body 803 from the screw mount 802 for a rest piece placement much higher along the body tube 803 than the typical rest piece and mounting systems can provide. This is useful for players who want their thumb to rest higher on the sax body than normal hooks or rests allow.

It is appreciated that the previous description of the disclosed embodiments is provided to enable any person skilled in the art to make or use the present disclosure. Various modifications to these embodiments will be apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

What is claimed:

1. A woodwind musical instrument rest piece for adjustable hand grip position and holding of the woodwind musical instrument comprising: 1) a rest piece having at least one open curved hole slot through which fasteners or a mounting system can secure the rest piece position, 2) the open curved hole slot path originates from the left lower quadrant or right lower quadrant of the rest piece, and the open curved hole slot path continues upward, 3) the open curved hole slot incorporates at least one curvature having a radius of between 10 mm and 35 mm which is measured along the centerline of the open curved hole slot path.

2. The rest piece of claim 1 wherein the rest piece includes embossed or debossed textures or high friction grip or adhesive grip.
